(19) United States
(12) Patent Application Publication
(10) Pub. No.: US 2017/0287053 A1
(43) Pub. Date: Oct. 5, 2017

(54) Methods and Systems for Remote Shopping

(71) Applicant: Wal-Mart Stores, Inc., Bentonville, AR (US)

(72) Inventors: Louis B. Page, Sunnyvale, CA (US); Ruth A. Blass, Bentonville, AR (US); Meriah D. Montondo, Rogers, AR (US); Kellie D. Embree, Bentonville, AR (US); Donald R. High, Noel, MO (US); Matthew A. Jones, Bentonville, AR (US); Courtland J. Halbrook, Centerton, AR (US)

(21) Appl. No.: 15/473,280

(22) Filed: Mar. 29, 2017

Related U.S. Application Data
(60) Provisional application No. 62/317,317, filed on Apr. 1, 2016.
(60) Provisional application No. 62/322,944, filed on Apr. 15, 2016.

(51) Int. Cl. G06Q 30/06; G06Q 20/20

(52) U.S. Cl. CPC G06Q 30/0635; G06Q 20/202

(57) ABSTRACT

In some embodiments, systems, apparatuses and methods are provided herein useful to facilitate and fulfill remote shopping or remote item selection. In some embodiments, a shopping system is provided that includes a shopping or selection user interface configured to receive a shopping list, a database of shopping lists, an item retriever user interface configured to display multiple shopping lists stored by the database, and a central computer. By one approach, the central computer presents a set of shopping lists, via the item retriever user interface, from the database of shopping lists, receives a list selection, receives an indication that one or more of the requested items has been retrieved from the item retriever user interface (or the point of sale terminals in communication with the central computer), and updates the database accordingly.

### CROSS-REFERENCE TO RELATED APPLICATIONS

This application claims the benefit of U.S. Provisional Application No. 62/317,317 filed Apr. 1, 2016, and U.S. Provisional Application No. 62/322,944 filed Apr. 15, 2016, which are incorporated herein by reference in their entirety.

### TECHNICAL FIELD

This invention relates generally to methods and apparatus for facilitating a remote shopping experience.

### BACKGROUND

Many people lead busy lives and struggle to find the time to finish all of their errands, such as shopping. Further, though many people would rather not spend time outside of work attending to household tasks and errands, they may not financially be able to hire full-time help. On the other hand, the time required to find someone to handle individual household tasks can eliminate any time savings generated by not handling the task oneself. Further, delegating household tasks, such as shopping, to an individual may require the transfer of significant responsibility and personal information to the individual performing the task. If numerous individuals are tapped to handle different household tasks, responsibility and personal information may be transferred to numerous individuals, which may be undesirable.

### BRIEF DESCRIPTION OF THE DRAWINGS

Disclosed herein are embodiments of systems, apparatuses and methods pertaining to remote shopping. This description includes drawings, wherein:

FIG. 1 is a simplified schematic block diagram of a system in accordance with some embodiments.

FIG. 2 is a simplified flow diagram in accordance with several embodiments.

FIG. 3 is a simplified schematic block diagram of a system in accordance with some embodiments.

FIG. 4 is a simplified flow diagram in accordance with several embodiments.

FIG. 5 is an illustrative system for use in implementing systems, apparatuses, devices, methods, techniques, and the like in managing the shopping system in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to provide a shopping system that facilitates having in-store shoppers retrieve items on a remote user's shopping list from a shelf within a retail location and bringing those items to a staging location to be subsequently claimed by the remote user or shopper. In some embodiments, the shopping system includes a selection or shopping user interface that receives a shopping list from a user (which may be remotely created), a database of a plurality shopping lists, an item retriever user interface that displays multiple shopping lists to an in-store shopper, a staging area, and a central computer or a control circuit. By one approach, the central computer is configured to present or display a set of shopping lists on an electronic device of an in-store shopper or item retriever located within a retail location, receive a list selection from the item retriever, provide the item retriever an opportunity to indicate that one of the plurality of requested items from the selected shopping list has been retrieved from a shelf location, receive such an indication, update the selected shopping list accordingly, and present an updated set of shopping lists based on the updated database. For example, the database may be updated to indicate a retrieved status of the one or more of the requested items that have been retrieved from the shelves of the retail location.

By one approach, the in-store item retrievers may have a handheld electronic device with the item retriever user interface such that the item retrievers may provide an indication that one or more of the requested items has been retrieved from the shelf in the retail location. For example, the item retriever may tap or select an item that they have pulled from the store shelves for a shopping list or may optically scan an identifier (such as by using an optical scanning device of the electronic user device to scan a bar code) on a retrieved product such that the handheld electronic device and the item retriever user interface may update the shopping list accordingly. In one approach, once the item retriever has indicated that a requested item has been retrieved, the item retriever may have the opportunity to check-out of a shopping list such that the shopping list may be updated and presented to other in-store item retrievers. In this manner, a plurality of in-store shoppers or item retrievers can collectively retrieve items from a remote shopper's list. In addition, this permits an in-store shopper to partially fulfill a user's shopping list. Accordingly, the central computer is configured to present some of the shopping lists in the database to more than one item retriever for partial fulfillment thereof. Alternatively, as discussed below in other configurations, selected shopping lists may be checked-out such that only a single item retriever is assigned to retrieve items from a singly selected shopping list at any given time until the assigned item retriever checks the list back in, such as, for example, at a point of sale terminal or another terminal device.

In one configuration, once an item retriever has picked up or retrieved one or more requested items from the shelf or aisle location of the retail location, the item retriever provides an indication of such retrieval to the central computer, which updates the database, and then the item retriever may deposit the retrieved item(s) at a staging location, where the remote user may collect or claim their requested items. By one approach, the staging location may include totes, bins, boxes, or other containers to sort and organize the various retrieved items for the plurality of shopping lists.

In one embodiment, the shopping user interface or a selection user interface is configured to receive transaction information from the user, such as name and contact information (i.e., email address and/or telephone number), but does not require payment information. In this manner, the shopping user interface or central computer does not complete the order until the user has collected one or more retrieved items from the retail location. To that end, the central computer may receive payment for the one or more retrieved items after the user arrives at the retail location to claim or collect the one or more requested items from the user's shopping list. Subsequently, when the user arrives at the store to collect their retrieved items, the central computer may update the database to indicate a purchased and collected status of the one or more retrieved items that the user has collected from the retail location.

In another embodiment, the central computer, via the shopping user interface, is configured to receive payment for the requested items from the user upon initial submission or receipt of the user's shopping list. For example, the shopping user interface may receive credit card or payment transaction information such as, during initial processing of the order. In this manner, the user may not be required to submit payment when arriving at the store to collect the requested shopping list items or order.

In one embodiment, the central computer determines which of the plurality of shopping lists to present to the item retrievers in the set based on the in-store shopper or item retriever's detected location within the retail location. The location may be detected by one or more sensors, such as, for example, optical sensors, location sensors including those incorporated into the electronic user devices, motion sensors, sound sensors, and/or a combination of these sensors, among others. In another embodiment, the central computer receives location information from the electronic device of the item retriever to determine which of the plurality of shopping lists to display.

Further, in one illustrative embodiment, the shopping user interface may present an opportunity to purchase one or more requested items and have the requested item(s) delivered to the user. By one approach, the requested items are delivered by one of the in-store item retrievers. In such a configuration, the central computer receives payment for the requested items, via the shopping user interface, and the user does not physically access the store to collect their requested items.

In one illustrative configuration, the in-store item retrievers are offered an opportunity to deliver a requested item and receive an incentive for such delivery. By one approach, the central computer receives the current location of the particular item retriever, a destination of the particular item retriever, and determines whether to present a delivery option after comparing the anticipated route of the item retriever with the delivery destination information received from the users. In another approach, the central computer will present the delivery opportunity to a plurality of item retrievers within a certain distance from the delivery destination. If an item retriever elects to deliver the retrieved and requested item(s), the item retriever is provided an opportunity to indicate that the retrieved and requested item(s) have been delivered. Furthermore, the users receiving the delivery of goods also may have the opportunity to indicate a satisfactory (or unsatisfactory) delivery. In one approach, upon receipt of delivery confirmation, the central computer updates the database of the plurality of shopping lists to indicate that the particular item retriever has delivered the particular requested item(s) to the user.

By one approach, the shopping user interface requests a user's desired pickup or collection time and collection location, and the central computer is configured to receive such information. In yet another approach, the shopping user interface requests a user's desired delivery time. Further, the central computer determines, in part, which of the shopping lists in the database to present to the item retriever in a set of shopping lists based on the user's preferred or requested collection time and location (or a delivery opportunity as discussed above). In one illustrative approach, the central computer is configured to automatically present a set of shopping lists to the item retriever upon the item retriever entering or approaching the retail location.

As used herein, the shopping or selection user interface and the item retriever user interface may be provided by or executed in communication with the central computer. By one approach, the shopping user interfaces and the item retriever user interfaces may be provided to electronic user devices by the central computer, such as, for example, by providing a software application (APP) that is available for download and installed in the electronic user devices. In another approach, the shopping user interfaces and the item retriever user interfaces may be executed by the electronic user devices when in communication with the central computer, e.g., the central computer provides one or both of the user interfaces to the electronic user devices for display (e.g., using a browser or viewer on the electronic user devices).

In operation, once an item retriever or in-store shopper has downloaded or otherwise accessed the selection or shopping user interface and signed up for or signed in with an account, when the in-store shopper arrives at the retail location, the user interface may automatically detect the in-store shopper's presence at the retail facility (if the electronic user device is so configured to provide such location services). Alternatively, the in-store shopper may be provided an opportunity to manually enter a location or store number. Upon detection or indication that the in-store shopper is at the retail facility, the selection or shopping user interface, in one configuration, presents shopping lists or carts that the in-store shopper may select and shop from. For example, the in-store shopper may select a cart or shopping list from which to retrieve items, and then, may select the particular retrieved items (or those which they are going to retrieve). In this manner, these retrieved items will not be displayed to other in-store shoppers for retrieval or these retrieved items will be displayed in a manner, such as being shaded, so that no other in-store shopper retrieves these. Further, if the in-store shopper decides not to retrieve items from a particular list, the in-store shopper may cancel item retrieval such that the items are once again included on the shopping list as needing retrieval.

To ensure proper retrieval of items from the shopping lists, the system also may confirm or cross check retrieval by scanning the items at the checkout or point of sale terminal. For example, a code from the user interface of the in-store item retriever may be scanned and then the items retrieved may be scanned to ensure the proper items were retrieved. This is particularly helpful for situations where the in-store item retriever has shopped or retrieved items from more than one list and/or has shopped for themselves in addition to picking items from shopping list(s) of remote shoppers. In one illustrative approach, after scanning the user interface code, the items in the in-store shopper's cart may be scanned and those from the remote user shopping list(s) may be placed in a location designated for items retrieved for remote shopper(s) (or merely set aside) without charging the customer. These items may then be marked or confirmed as retrieved in the remote user shopping list. Further, the items scanned at the point of sale terminal and not found on a remote user shopping list accessed by the in-store shopper will be added to the in-store shopper's personal receipt and charged as normal. By one approach, once item(s) from the remote user shopping list(s) are identified at the point of sale terminal a notification may be sent to a store worker or associate that there are items to be gathered or prepared for pick up by a remote shopper. Given that numerous in-store shoppers may be retrieving items for a single shopping list, these items may be gathered and organized for distribution to the remote shoppers. In one illustrative approach, the in-store shopper receives rewards, such as discounts, store credit, or other remuneration, for the items collected or retrieved from the remote user's shopping list.

In yet another, similar embodiment, the in-store shoppers retrieve items and bring the items to the point of sale terminal for processing, to be subsequently claimed by the remote user or shopper. In such a configuration, the shopping system includes a selection user interface that receives a shopping list from a user (which may be remotely created), a database of a plurality shopping lists, an item retriever user interface that displays multiple shopping lists to an in-store shopper, a point of sale terminal, and a central computer. By one approach, the central computer is configured to present or display a set of shopping lists on an electronic device of an in-store shopper or item retriever located within a retail location, receive a list selection from the item retriever, receive an indication from a point of sale terminal that one of the requested items has been retrieved, and update the selected shopping list accordingly. For example, the database may be updated to indicate a retrieved status of the one or more of the requested items that have been retrieved from the shelves of the retail location.

In one such illustrative approach, once a user has selected a shopping list from which to retrieve items, the central computer indicates that the selected shopping list is checked-out and unable to be viewed by other item retrievers until the point of sale terminal receives an indication that one or more of the plurality of requested items has been retrieved. In this manner, only a single in-store shopper or item retriever is pulling or retrieving items from the shelves of the retail location for a particular shopping list in such a configuration.

In another illustrative embodiment, customers or users are able to remotely submit a shopping list according to a method described herein including, for example, presenting an opportunity for a user to create a shopping list, via a shopping or selection user interface of a user electronic device, maintaining a database of shopping lists created by users, presenting an item retriever in a retail location a set of shopping lists from the plurality of shopping lists in the database, and receiving a list selection from the set of presented shopping lists. Further, the method may include providing the item retriever an opportunity to indicate that one of the plurality of requested items from the selected shipping list has been retrieved from a shelf location of the retail location, and receiving, from the retriever user interface (or from the point of sale terminal in another manner discussed below), an indication that at least one of the requested items from the shopping list has been retrieved. In addition, the method may include updating the selected shopping list in the database according to the information received from the item retriever user interface and present an updated set of shopping lists to the item retrievers accordingly. For example, the selected shopping list may be updated in the database to indicate a retrieved status of the requested items in the shopping list that were retrieved.

By one approach, the method includes presenting at least one of the shopping lists to multiple item retrievers via multiple item retriever user interfaces for partial fulfillment by some of the multiple item retrievers. In operation, when the item retrievers deposit the retrieved items at a staging area, a terminal may be used to scan a code or indicator on the user interface of the electronic device of the item retriever to associate the particular items retrieved with the particular shopping list from which the item retriever had been shopping.

In another illustrative configuration, the method may include receiving, from a point of sale terminal, an indication that at least one of the requested items from the shopping list has been retrieved from a shelf location of the retail location and updating the selected shopping list according to the information received at the point of sale terminal. For example, the selected shopping list may be updated in the database to indicate a retrieved status of the requested items in the shopping list that were retrieved. In this manner, the point of sale terminal may operate similarly to the staging area terminal and an optical scanning device of the electronic user device of other embodiments discussed herein.

Within the retail facility or location, the retrieved items may be deposited in an area where the users or remote shoppers may be able to claim or collect their requested items. Thus, once the requested items have been retrieved by the item retriever and scanned by the retriever with the electronic user device or scanned by someone at the point of sale terminal, the retrieved items may be deposited in a staging location where the remote shoppers or users can claim or collect their requested items. Accordingly, the method may further include updating the selected shopping list to indicate that one of the requested items has been deposited in the staging location. In one illustrative embodiment, the user or remote shopper may only need to drive up to a designated area of the staging area such that an associate at the retail location is able to deliver the requested items to the user in their vehicle and receive payment for the requested items. In yet another embodiment, the user or remote shopper may physically enter the retail location or otherwise access a staging area of the retail location to collect their requested items and provide payment therefore.

By one approach, the method also may include receiving a collection time and collection location associated with a shopping list. Based on that information, the method may determine which of the plurality of shopping lists to present in the set of shopping lists to the item retriever. In another approach, the method determines which of the plurality of shopping lists to present in the set of shopping lists based on a particular item retriever's detected location within the retail location.

By one approach, the method includes presenting to the user an opportunity to have a requested items delivered by one of the item retrievers. Further, by one approach, the method includes determining whether to present a delivery opportunity to one of the item retrievers based on the item retriever's current location and their destination in comparison with the delivery location of the user. In another approach, the method may present a delivery opportunity to all of the item retrievers interested in receiving such opportunities within a certain distance from the delivery destination. In one embodiment, the user and/or the item retriever who delivers the requested items are prompted to confirm satisfactory delivery of the requested items.

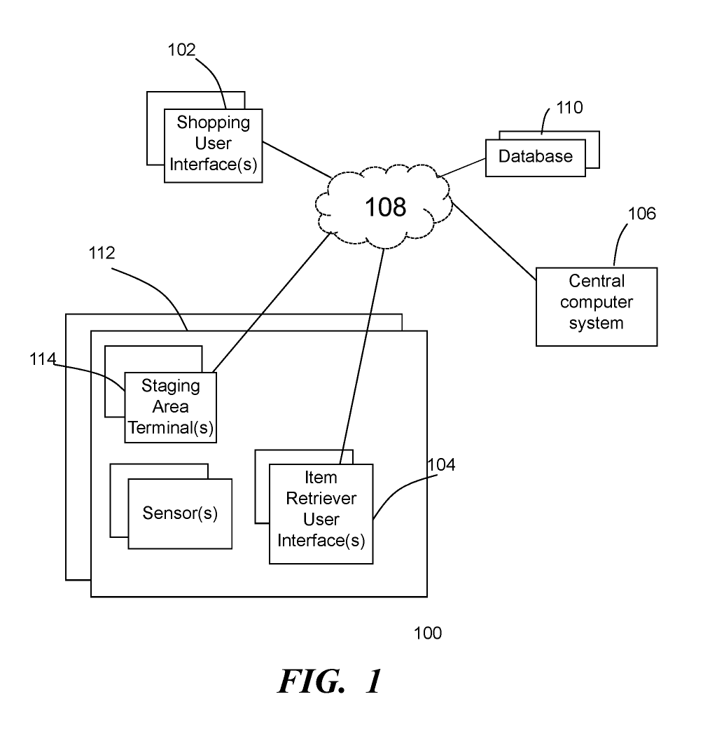

FIG. 1 illustrates a simplified block diagram of an exemplary shopping system 100, according to some embodiments, which facilities remote shopping for a customer or user, who may then retrieve the requested items from the selected retail location or may elect to have them delivered by an item retriever. The shopping system 100 includes shopping user interface(s) 102, item retriever user interface(s) 104, a control circuit or central computer system 106, a database 110 of a plurality of shopping lists having one or more requested items, and a staging area to contain the retrieved items with a staging area terminal 114. As illustrated, the interfaces 102, 104 (which may be operated at one or more interface units or electronic user devices) may be communicatively coupled over one or more distributed communication networks 108 with the control circuit or central computer system 106, the database 110, and the staging area terminal 114, directly or indirectly, such as through a network 108 (e.g., LAN, WAN, Internet, cellular, Wi-Fi, other such communication networks or combination of two or more of such networks).

By one approach, the shopping user interfaces 102 provide the remote shopper or user the opportunity to remotely shop for items sold within a retail location. In this manner, a user may shop on an electronic device, such as a smart phone, tablet, or laptop computer, among others, for various retail items. For example, a user may access a web address, URL address, or a mobile application that presents the items available for purchase from the retail location. Further, the user may select the various items they would like to purchase by, for example, placing them into a shopping cart or onto a shopping list. In addition, the remote user may submit the shopping list with the requested items and request that a particular retail location or facility have the requested items retrieved for the user from the shelves of the retail location such that the requested items are ready for pickup or collection by the remote shopper or user without requiring the user to individually retrieve each of the requested items from their shelf or aisle location of the retail location.

In one illustrative approach, the user employs the shopping user interface 102 to place desired or requested items onto an electronic shopping list or into an electronic shopping cart, but does not purchase the items through the shopping user interface 102. Instead, in such a configuration, the user may supply identifying information, such as, for example, name and contact information (i.e., telephone number or email address), but in such a configuration, the user does not supply payment information, such as a credit card number, until the user arrives at the retail location to claim the requested items.

In another approach, the shopping user interface 102 may receive payment information from the user, but the shopping user interface 102 or central computer system 106 does not process the payment or credit card information unit the user has collected or claimed the requested items at the retail location.

In yet another approach, the shopping user interface 102 receives payment information, such as credit card information, from the user and processes the payment before the retrieved items are retrieved or delivered, if the user has elected to have the retrieved items delivered. By one approach, the payment information is processed before the shopping list is presented to the item retrievers.

In one embodiment, the shopping system 100 permits the remote shopper or user to select a pickup or collection location and/or a pickup or collection time, in addition to the selection of requested items and provision of information. By one approach, the collection location is one of a plurality of retail locations. Thus, when the user is creating a shopping cart or shopping list of requested items and submitting the shopping list to the central computer system 106, the user also may submit a convenient time and location for the user to collect the requested items. By one approach, the central computer 106 provides the user with optional collection locations and collection times. For example, the central computer system 106 may present available collection locations based on previously submitted shopping lists or the remote user's current location and may present available collection times based on the number of requested items in the shopping list and the store hours of the selected collection location, among others.

If the user has selected the delivery option mentioned above, the central computer may not provide the user the opportunity to select a collection time or location, but instead, may present the delivery opportunity to a plurality of item retrievers, some of which may be disposed at different retail locations. Once an item retriever has selected to deliver the requested items, the central computer 106 will update the database 110 to indicate that the shopping list has been assigned to an item retriever for delivery.

By one approach, the electronic shopping list is created or submitted at the shopping user interface 102 and saved and/or maintained in the database 110. Accordingly, the database 110 may include a plurality of shopping lists with requested items that were submitted by users at the shopping user interfaces 102. In one illustrative example, the database 110 also maintains transaction information (such as contact name, email, or telephone number) associated with each of the shopping lists in the database 110. By one approach, the database 110 may maintain a status of the shopping list, such as, for example, list received, retrieval in progress, items collected, delivery in progress, and delivered. Further, in one illustrative approach, the database 110 also maintains a status of the individual requested items on the shopping list. Thus, if an in-store shopper or item retriever has retrieved some, but not all, of the requested items, the status of the individuals requested items will reflect this partial list retrieval. In this manner, the database 110 and the central computer 106 may facilitate partial shopping list fulfillment with a plurality of item retrievers.

As suggested above, the system 100 may include a plurality of retail facilities or retail locations 112, from which a user may pick up their requested items. Further, the retail location 112 may have one or more a specific locations designated for pick up or retrieval of requested items such as, for example, from a service desk, drive through, staging area, secure locker location and/or distribution center, among other locations. As illustrated in FIG. 1, the retail locations 112 may include one or more item retriever user interfaces 104 and one or more staging areas with staging area terminals 114. The staging area terminal 114 may scan the products (or a list identifier on the electronic user device of the item retriever) such that the database can be updated to indicate that the items retrieved are now at the staging area and may be picked up or collected by the remote shopper or combined with other items retrieved for subsequent collection. By one approach, the item retriever user interface 104 is presented on an electronic user device, which may be used within the retail locations 112. As used herein, a retail location includes a store or establishment open to selling goods or items to the public and typically includes a plurality of aisles with shelves therein that display the goods or items available for purchase. Many retail locations 112 are quite large and it can require substantial time to navigate the aisles to retrieve the items on one's shopping list. While shopping for one's own goods, an in-store shopper or item retriever may desire to assist the retail location 112 in fulfilling other orders or requests (i.e., the remote shopper's lists) to qualify for a discount, promotional item, or other similar incentive.

To that end, an in-store shopper may use an item retriever user interface 104, which may be downloaded or otherwise loaded onto an item retriever or in-store shopper's electronic device. The item retriever user interface 104 is configured to display multiple shopping lists stored by the database 110. The central computer system 106 is configured to present a set of shopping lists from the plurality of shopping lists in the database 110 for display on the in-store shopper's electronic device via the item retriever user interface 104.

Further, the central computer system 106 may determine which of the shopping lists from the database 110 to present to the item retriever based upon the item retriever's retail location and the current time. For example, if the item retriever is shopping at a retail location that a remote shopping user has selected as the collection location and within a certain amount of time proximate the user's selected collection time, the central computer system 106 may decide to present that shopping list to the item retriever for help fulfilling the shopping list by retrieving requested items. Depending on the number of shopping lists within the database 110, the item retriever may have a large number of shopping lists from which to choose. By one approach, as the in-store shopper approaches or enters the retail location, the central computer system 106 may present the in-store shopper or item retriever with available shopping lists from which to retrieve requested items. By another approach, the in-store shopper or item retriever may be presented with available shopping list at any time during a visit to the retail location. In this manner, an in-store shopper or item retriever may retrieve the requested items from a selected shopping list and then subsequently select another shopping list from which to shop or retrieve items.

By one approach, the central computer 106 may decide which shopping lists to present based on the item retriever's location detected within the retail location 112. For example, if an item retriever is located in the dairy aisle, the central computer system 106 may decide to display or present shopping lists with milk as one of the requested items. To that end, one or more location sensors 118 may be disposed in the retail location 112 to track the in-store item retrievers. By one approach, this occurs via the electronic user devices on which the item retriever user interface 104 is displayed.

In one illustrative approach, the item retriever user interface 104 is configured to request and/or obtain information about the in-store shopper or item retriever. For example, the user interface 104 may obtain name, contact information, age, physical capabilities, and other details about the shopper. Furthermore, the central computer system 106 may decide not to present a shopping list with alcoholic beverages to an item retriever who has not reached the legal drinking age. By way of another example, if an item retriever has requested not to shop for items over a certain size, the central computer system 106 may not present the item retriever with a shopping list that includes large bags of dog food over the certain size.

In one aspect, the item retriever user interface 104 is configured to display the requested items from the selected one of the shopping lists. This may occur once the in-store shopper or item retriever has selected a shopping list or alternatively, the requested items or a portion thereof may be visible to the item retriever before selecting a particular shopping list.

In one embodiment, the item retriever user interface 104 provides item retrievers the opportunity to indicate that one of the plurality of requested items has been retrieved from a shelf location of retail facility or retail location 112. To facilitate multiple shoppers retrieving items from multiple shopping lists, the item retriever user interface 104 also may provide the item retrievers an opportunity to continue shopping for the same selected list once an item has been retrieved or may provide the item retrievers the opportunity to check in the list such that other item retrievers can continue shopping for the requested items on the shopping list. In this manner, if the customer in the diary aisle and selects a shopping list with milk as a requested item, and then locates the requested milk, places the milk in his cart, and then indicates that the requested item has been retrieved from the shelf, the shopper's item retriever user interface 104 may then prompt him to indicate whether he would like to continue to shop for items from this shopping list or whether he wants to stop retrieving items from the previously selected shopping list. By one approach, the item retriever user interface 104 may have the ability to scan a barcode on the retrieved items such that the user interface 104 and the central computer 106 may confirm that the correct items was retrieved.

In one embodiment, when the in-store shopper or item retriever is finished shopping, the item retriever delivers the retrieved items to a staging area where an associate may receive and process the retrieved items at a staging area terminal. By one approach, the item retriever may scan or input identifying information of the shopping list(s) from which items were retrieved and the staging area terminal can associate the retrieved items from the shopping list(s) or flag incorrectly retrieved items. This may be particularly beneficial in configurations without item retriever user interfaces 104 having a scanning function to confirm that the items retrieved by the shoppers corresponds to the requested items of the user.

The control circuit or central computer system 106 illustrated in FIG. 1 is in communication with the database 110, the shopping user interfaces 102, the items retriever user interfaces 104, and the staging area terminals 114. As illustrated in FIG. 1, the staging area terminals 114 are located within a retail location and the item retriever user interface 104 may be displayed on an electronic device that is disposed within the retail location 112 for at least a certain amount of time. The central computer system 106 or a portion thereof also may be disposed within one or more of the retail locations 112. By one approach, the shopping user interface 102 and/or the item retriever user interface 104 are provided to the electronic user devices by the central computer. By another approach, the shopping user interface 102 and/or the item retriever user interface 104 are executed by the electronic user devices when in communication with the central computer 106.

In one illustrative example, the central computer system 106 is configured to receive payment for the retrieved items after the user arrives at the retail location to claim the one or more requested items from the user's shopping list. Further, the central computer 106 may update the status of the shopping list in the database after payment and collection, such as by marking a shopping list as collected or completed.

In another embodiment, the central computer 106 is configured to receive payment for the requested items upon receipt of the shopping list. Further, by one approach, the user may select a delivery option that uses in-store item retrievers to deliver the requested items to the user.

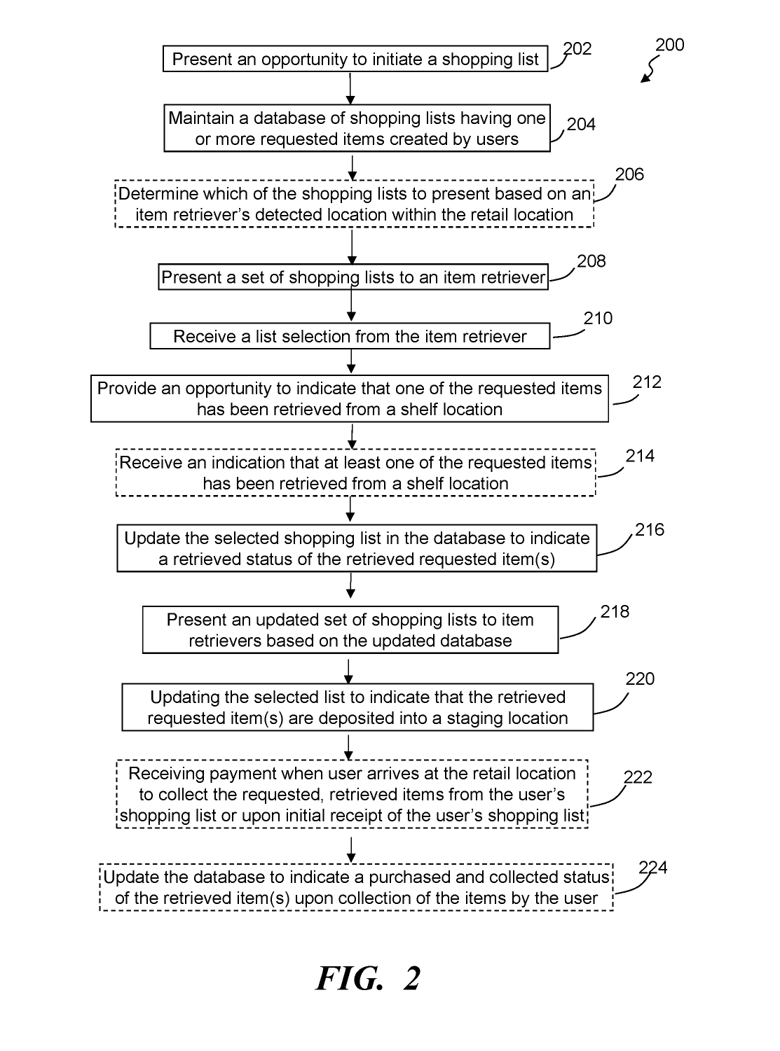

Referring now to FIG. 2, a process 200 for receiving, facilitating, and managing shopping lists according to some embodiments discussed herein is illustrated. The method 200 includes, for example, presenting 202 an opportunity for a remote shopper to create a shopping list with requested items. By one approach, the opportunity may be presented 202 via a shopping user interface of an electronic user device. In one example, the presentation includes the retail items available for purchase at a retail location. In one illustrative embodiment, this includes presenting optional retail locations and times at which the remote user may collect their retrieved shopping list. Accordingly, the method 200 also may include receiving a selected collection time and collection location associated with a particular shopping list. In one embodiment, the presentation includes presenting an opportunity to provide transaction information from the user such as a user's name and contact information. In one illustrative approach, the user is presented with an opportunity to provide payment information. In still another embodiment, the method 200 present an opportunity to have the requested items delivered to a remote shopper or user by one of the in-store item retrievers.

In step 204, a database of a plurality of shopping lists having one or more requested items is maintained. By one approach, the maintenance 204 of the database may include maintaining a status of the shopping list such as received, partial retrieval of requested items, complete retrieval, disposed at staging area, ready for collection, purchased and collected, purchased and out for delivery, and delivered, among others. By yet another approach, maintaining 204 the database may include maintaining a collection time and collection location associated with the shopping list. Alternatively, the database may be maintained 204 with a delivery status.

In step 206, a determination is made regarding which of the shopping lists to present to an item retriever based on the item retriever's detected location within the retail location. Further, in step 208, a set of shopping lists from a plurality of shopping lists in the database is presented to an item retriever via the item retriever user interface of an electronic device. By one approach, the process 200 determines which of the plurality of shopping lists in the database to present to the in-store shopper or item retriever based on the collection time and collection location received from the user and the retail location of the in-store shopper and the time at which the item retriever is shopping at the retail location. The central computer 106 may present one of the shopping lists to multiple item retrievers for partial fulfillment by at least some of the many item retrievers.

By one approach, the presentation 208 of a set of shopping lists to an item retriever also may include presenting the item retriever the opportunity to deliver requested delivery items based on a current location of the particular item retriever and a destination of the particular item retriever and the delivery location.

In step 210, a list selection is received from the in-store shopper or item retriever, which also may include a shopping list with a delivery opportunity. By one approach, after receipt of a list selection, the process 200 also may indicate 210 that the selected shopping list is checked-out and unavailable or unable to be viewed or selected by other item retrievers until the item retriever indicates that they no longer wish to retrieve items requested on the shopping list or when the item retriever deposits the retrieved items at the staging area. In another approach, if a predetermined amount of time has passed without the item retriever indicating that a requested item has been retrieved, the central computer may automatically check in the shopping list so that it can be selected by other item retrievers.

In step 212, an opportunity is provided to indicate that one of the requested items has been retrieved from a shelf location. Accordingly, in step 214, an indication is received at the item retriever user interface 104 that at least one of the requested items has been retrieved from a shelf location in the retail location.

The process 200 also updates 216 the selected shopping list in the database according to input received at the item retriever user interface 104 to indicate a retrieved status of the retrieved items. Further, updating 216 the selected shopping list also may include updating the status of the shopping list such as indicating that the selected shopping list is no longer checked-out, and is available for another in-store shopper or item retriever to retrieve any remaining requested items that have not yet been retrieved. The process 200 also may include updating 216 the selected list to indicate that the retrieved, requested items are deposited in a staging location.

After the in-store shopper or item retriever has retrieved items, the items may be deposited into a staging area to be processed by a staging area terminal and/or to await collection by the remote shopper or user. In another embodiment, the process includes having the requested items delivered by an item retriever by providing delivery location information to the item retriever.

In step 218, an updated set of shopping lists is presented to item retrievers based on the updated database. As mentioned above, as the item retriever user interfaces are configured to receive an indication that one of the requested items has been retrieved, the shopping list can be updated before the retrieved items are deposited into the staging area. Accordingly, the shopping list can be presented to other item retrievers before the other retrieved items are deposited into a staging area, if an item retriever has elected not to continue retrieving items from the list.

Once one or more retrieved items are deposited into a staging area, the staging area terminal may update the selected list in the database to indicate which items have been retrieved and deposited in the staging area. Accordingly, in step 220, the selected list is updated in the database to indicate that the retrieved, requested items are deposited in the staging location.

As discussed above, the method 200 also may include receiving 222 payment information when a user arrives at the retail location to collect or claim the requested, retrieved items or upon initial receipt of the user's shopping list.

To that end, once the retrieved items have been purchased and collected or purchased and delivered, the database is updated 224 accordingly.

If all of the requested items from the shopping list have been retrieved and a user has not elected to have the requested items delivered, the process may send an indication to the remote shopper or user that the requested items from the shopping list are ready for pickup. If less than an entire shopping list has been retrieved, the shopping list is typically available for other in-store shoppers or item retrievers to retrieve items therefore. Alternatively, if a remote shopper or user's collection time is imminent, an associate at the retail location may choose to complete the order to expedite fulfillment.

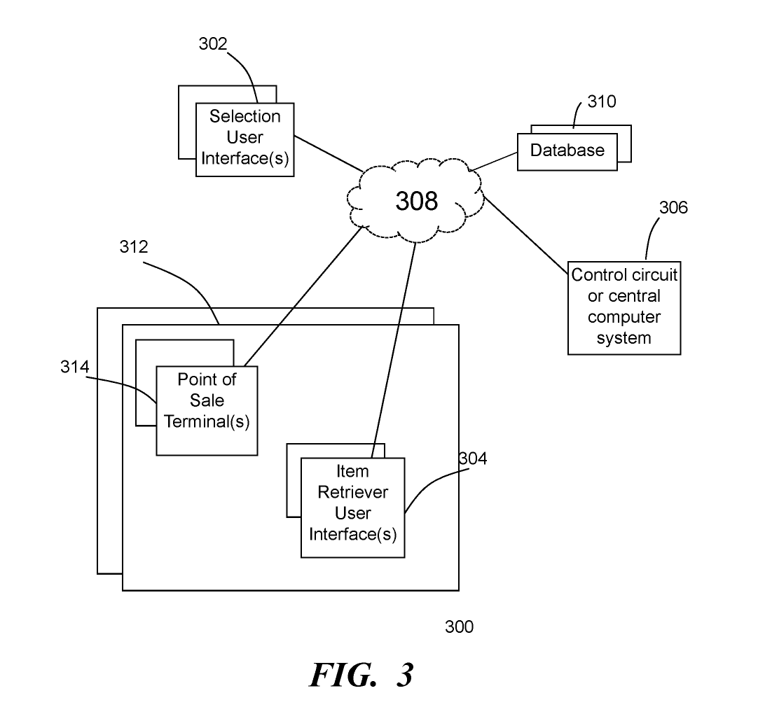

FIG. 3, illustrating another simplified block diagram, includes an exemplary shopping system 300, according to some embodiments, which facilities remote shopping for a customer or user, who may then retrieve the requested items from the selected retail location (or have them delivered as mentioned above). The shopping system 300 includes selection user interface(s) 302 (similar to shopping user interface 102), item retriever user interface(s) 304 (similar to user interface 104), a control circuit or central computer system 306 (similar to central computer 106), a database 310 (similar to database 110) of a plurality of shopping lists having one or more requested items, and one or more point of sale terminals 314. As illustrated, the interfaces 302, 304 (which may be operated at one or more interface units or electronic user devices) may be communicatively coupled over one or more distributed communication networks 308 with the control circuit or central computer system 306, the database 310, and the point of sale terminals 314, directly or indirectly, such as through a network 308 (similar to those described above). Whereas the system 100 permits multiple in-store item retrievers to pick items, the system 300 typically checks out or assigns the shopping list to a particular retriever until that retriever has brought the items to the point of sale terminal 314 for scanning or processing before releasing the checked out list to other item retrievers that can retrieve the items not gathered by the previous item retriever.

By one approach, the selection user interface 302 is configured to receive transaction information, including for example, the remote shopper or user's name and contact information, but does not complete an order until the user has collected the requested items that an in-store item retriever has retrieved from the shelves and/or aisles of the retail location. The selection user interface 302, similar to shopping user interface 102, may or may not receive and/or process payment information at the time the list of requested items is received. In one illustrative embodiment, a remote user may add requested items after the shopping list is created.

The system 300, such as, for example, via the selection user interface 302, also permits the user to select a collection location and/or time. As noted above, optional collection locations and/or times may be presented to the remote shopper based on previously submitted orders (or lists), or the remote shopper's current location. By one approach, these optional times or selected times may be presented or adjusted based on store hours, associate availability, and/or available variable collection times, among other factors.

By one approach, the electronic shopping list is created or submitted at the selection user interface 302 and saved and/or maintained in the database 310, similar to previously described shopping lists. In addition to maintaining transaction information (such as contact name, email, and/or telephone number) associated with each of the shopping lists, the database 310 also may indicate if a shopping list is checked out (and optionally, the in-store item retriever assigned to the list). Further, the database 310 may maintain a status of the shopping list, such as, for example, list received, retrieval in progress, and items collected. In one illustrative approach, the database 310 also maintains a status of the individual requested items on the shopping list. Thus, if an in-store shopper or item retriever has retrieved some, but not all, of the requested items, the status of the individuals requested items will reflect this partial list retrieval.

The retail locations 312, as shown in FIG. 3, may include one or more item retriever user interfaces 304 and one or more registers or point of sale terminals 314. The point of sale terminal 314 may scan items retrieved from the store shelves by the item retriever and indicate a retrieved status in the database. Further, the shopping list may be checked in by the item retriever at the point of sale terminal such that other item retrievers can retrieve any unpicked items remaining on the shopping list.

In one illustrative approach, an in-store shopper may retrieve items from an online or remote shopper's electronic shopping list, place them in their physical shopping cart, and at check-out, the point of sale terminal may receive notice of the particular electronic shopping list from which the in-store shopper has retrieved items. In this manner, the point of sale terminal may indicate when an item is scanned from the particular electronic shopping, thereby notifying the clerk and/or in-shopper that the scanned item(s) should be placed in an area reserved for items retrieved form the electronic shopping list. The in-store shopper or item retriever may then receive a reward or other incentive, such as through a rewards program, for the retrieval of items from the electronic shopping list. By one approach, the in-store item retriever is rewarded based on the quantity of items retrieved, which is verified by or at the point of sale terminal. Once the items retrieved from the electronic shipping list are identified or verified by the point of sale terminal, the rewards or incentives, such as points or credits may be given to the in-store shopper or applied to an account associated therewith. The system also may permit evaluation of the in-store shopper such that the in-store shoppers may be given a rating by the remote shoppers. In some configurations, the rating may need to be maintained at a sufficiently high enough status for the in-store shopper to retain the ability to shop for other, remote shoppers and earn incentives.

When an in-store shopper or item retriever has selected a shopping list from which to shop, the central computer system 306 and/or database 310 may indicate that the selected shopping list is checked-out, unavailable, and/or unable to be viewed by other item retrievers. By one approach, the selected shopping list is unavailable for other item retrievers until the point of sale terminal receives an indication that one or more of the plurality of requested items has been retrieved. By another approach, the item retriever may manually check-in a selected shopping list if the item retriever decides not to retrieve the requested items from the shopping list.

In one embodiment, when the in-store shopper or item retriever is finished shopping from a selected shopping list, the item retriever delivers the retrieved items to a register or point of sale terminal 314. By one approach, the item retriever may scan or input identifying information of the shopping list thereby permitting the point of sale terminal to associate the retrieved items with the particular selected shopping list. In one aspect, an associate of the retail location (or the item retriever themselves if a self-checkout terminal is available) may scan the retrieved items and determine what items from the shopping list have been retrieved. In one illustrative embodiment, by having the point of sale terminal compare the items retrieved by the in-store shopper or item retriever with the requested items of the selected shopping list, the risk of having a remote shopper or user receive incorrect items is reduced.

In one aspect, the point of sale terminal 314 is configured to establish that the items retrieved are from the shopping list, but does not receive payment for the retrieved items at that time. Instead, the remoter shopper or user may submit payment for these items at the time of collection. Once the item retriever has had the items processed at the point of sale terminal 314, the retrieved items may be delivered to a staging area for pickup or collection by the remote shopper or user.

In another aspect, once the item retriever has checked out or provided the identifying information of the shopping list to the point of sale terminal, such that the point of sale terminal can compare the retrieved items with the selected shopping list, the in-store shopper or item retriever may select another shopping list from which to retrieve requested items.

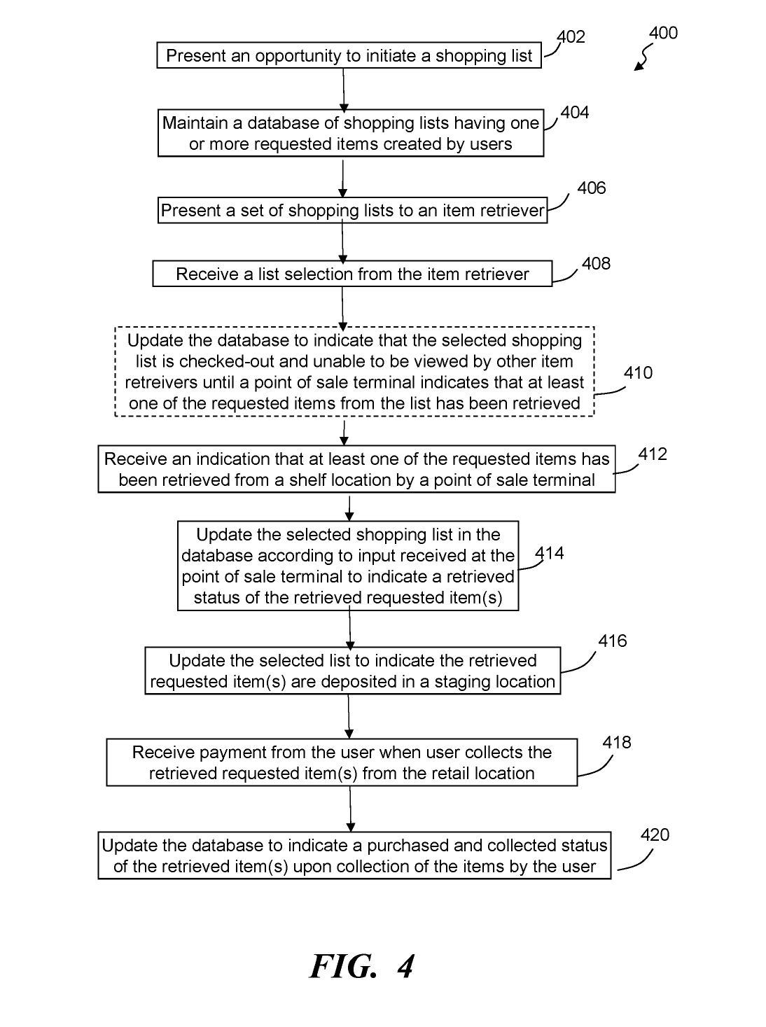

Referring now to FIG. 4, a process 400 for receiving, facilitating, and managing shopping lists according to some embodiments discussed herein is illustrated. The method 400 includes, for example, presenting 402 an opportunity for a remote shopper to create a shopping list with requested items. By one approach, the opportunity may be presented 402 via a selection user interface of an electronic user device. In one example, the presentation includes the retail items available for purchase at a retail location. In one illustrative embodiment, this includes presenting optional retail locations and times at which the remote user may collect their retrieved shopping list. Accordingly, the method 400 also may include receiving a selected collection time and collection location associated with a particular shopping list. In one embodiment, the presentation includes presenting an opportunity to provide transaction information from the user such as a user's name and contact information. In one illustrative approach, the user is presented with an opportunity to provide payment information, though the process 400 does not process the payment until the user collects the requested items.

In step 404, a database of a plurality of shopping lists having one or more requested items is maintained. By one approach, the maintenance 404 of the database may include maintaining a status of the shopping list such as received, checked out for item retrieval, processing at point of sale terminal, partial retrieval, complete retrieval, disposed at staging area, ready for collection, purchased, and collected, among others. By yet another approach, maintaining 404 the database may include maintaining a collection time and collection location associated with the shopping list.

In step 406, a set of shopping lists from a plurality of shopping lists in the database is presented to an item retriever via the item retriever user interface of an electronic device. By one approach, the process 400 determines which of the plurality of shopping lists in the database to present to the in-store shopper or item retriever based on the collection time and collection location received from the user and the retail location of the in-store shopper and the time at which the item retriever is shopping at the retail location.

In step 408, a list selection is received from the in-store shopper or item retriever. By one approach, after receipt of a list selection, the process 400 also may update or indicate 410 that the selected shopping list is checked-out and unavailable or unable to be viewed or selected by other item retrievers until the point of sale terminal receives an indication that at least one of the requested items has been retrieved.

In step 412, an indication is received at the point of sale terminal that at least one of the requested items has been retrieved from a shelf location in the retail location.

The process 400 also updates 414 the selected shopping list in the database according to input received at the point of sale terminal to indicate a retrieved status of the retrieved items. Further, updating 414 the selected shopping list also may include updating the status of the shopping list such as indicating that the selected shopping list is no longer checked-out, and is available for another in-store shopper or item retriever to retrieve any remaining requested items that have not yet been retrieved.

After the in-store shopper or item retriever has brought the requested and retrieved items to one of the point of sale terminals, the items may be deposited into a staging location to await collection by the remote shopper or user. The process 400 also may include updating 416 the selected list to indicate that the retrieved, requested items are deposited in a staging location.

If all of the requested items from the shopping list have been retrieved, the process may send an indication to the remote shopper or user that the requested items from the shopping list are ready for pickup. If less than the entire shopping list has been retrieved, the shopping list may become available for another in-store shopper or item retriever to select once the list is no longer checked out. Alternatively, if the remote shopper or user's collection time is imminent, an associate at the retail location may choose to complete the order.

When the user arrives at the retail location to collect the requested items from the shopping list, payment 418 is received from the remote shopper or user. As noted above, payment for the requested items is typically not received until the user has arrived at the store to collect the requested items. By one approach, the remote shopper or user presents payment for the requested items upon arrival at the retail location. By yet another approach, the remote shopper or user has submitted payment information to the selection user interface, but payment is not processed until the remote shopper or user collects the requested items at the selected collection location.

Finally, in step 420, the database is updated to indicate a purchased and collected status of the retrieved items upon collection of the items by the user.

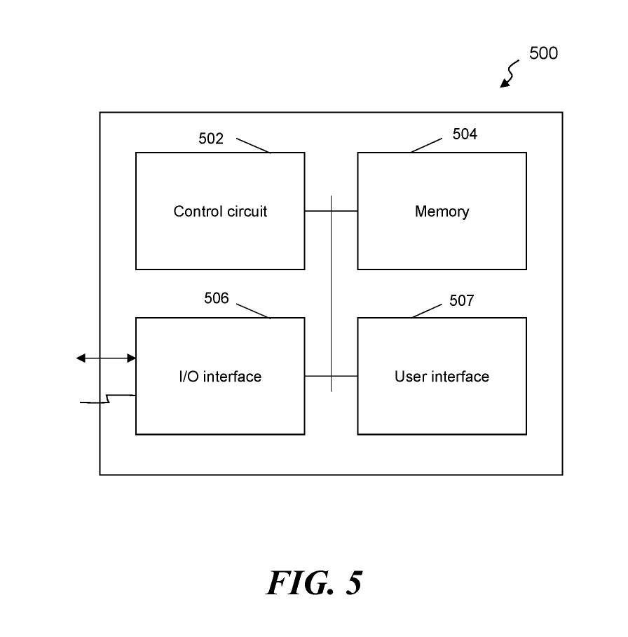

The methods, techniques, systems, devices, services, servers, sources and the like described herein may be utilized, implemented and/or run on many different types of devices and/or systems. Referring to FIG. 5, there is illustrated a system 500 that may be used for any such implementations, in accordance with some embodiments. One or more components of the system 500 may be used to implement any system, apparatus or device mentioned above or below, or parts of such systems, apparatuses or devices, such as for example any of the above or below mentioned shopping system 100 or 300, central computer system 106, 306, shopping or selection user interfaces 102, 302, item retriever user interfaces 104, 304, staging area terminals 114 or point of sale terminals 314, databases 110, 310, and the like. However, the use of the system 500 or any portion thereof is certainly not required.

By way of example, the system 500 may include one or more control circuits 502, memory 504, and input/output (I/O) interfaces and/or devices 506. Some embodiments further include one or more user interfaces 508. The control circuit 502 typically comprises one or more processors and/or microprocessors. The memory 504 stores the operational code or set of instructions that is executed by the control circuit 502 and/or processor to implement the functionality of the shopping system 100, 300, central computer system 106, 306, shopping or selection user interfaces 102, 302, item retriever user interfaces 104, 304, staging area terminals 114, point of sale terminals 314, database 110, and the like. In some embodiments, the memory 504 may also store some or all of particular data that may be needed to present an opportunity to create shopping lists, maintain the database of shopping lists, present a set of shopping lists to an item retriever, receive a list selection, receive an indication that requested items have been retrieved from the item retriever user interface or the point of sale terminal, and update the database, and make any of the associations, determinations, measurements and/or communications described herein. Such data may be pre-stored in the memory, received from an external source, be determined, and/or communicated to the system.

It is understood that the control circuit 502 and/or processor may be implemented as one or more processor devices as are well known in the art. Similarly, the memory 504 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 504 is shown as internal to the system 500; however, the memory 504 can be internal, external or a combination of internal and external memory. Additionally, the system typically includes a power supply (not shown), which may be rechargeable, and/or it may receive power from an external source. While FIG. 5 illustrates the various components being coupled together via a bus, it is understood that the various components may actually be coupled to the control circuit 502 and/or one or more other components directly.

Generally, the control circuit 502 and/or electronic components of the system 500 can comprise fixed-purpose hard-wired platforms or can comprise a partially or wholly programmable platform. These architectural options are well known and understood in the art and require no further description here. The system and/or control circuit 502 can be configured (for example, by using corresponding programming as will be well understood by those skilled in the art) to carry out one or more of the steps, actions, and/or functions described herein. In some implementations, the control circuit 502 and the memory 504 may be integrated together, such as in a microcontroller, application specification integrated circuit, field programmable gate array or other such device, or may be separate devices coupled together.

The I/O interface 506 allows wired and/or wireless communication coupling of the system 300 to external components and/or or systems. Typically, the I/O interface 506 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 508 may be used for user input and/or output display. For example, the user interface 508 may include any known input devices, such one or more buttons, knobs, selectors, switches, keys, touch input surfaces, audio input, and/or displays, etc. Additionally, the user interface 508 include one or more output display devices, such as lights, visual indicators, display screens, etc. to convey information to a user, such as but not limited to customer information, shopping lists, available items, requested items, product orders, product information, communication information (e.g., text messages, emails, etc.), status information, notifications, errors, conditions, and/or other such information. Similarly, the user interface 508 in some embodiments may include audio systems that can receive audio commands or requests verbally issued by a user, and/or output audio content, alerts and the like.

In some embodiments, systems, apparatuses, and methods are provided to receive, facilitate and fulfill remote shopping. In some configurations, a shopping system is provided that includes a shopping user interface configured to receive a shopping list, a database of shopping lists, an item retriever user interface configured to display multiple shopping lists stored by the database and permit a retriever to scan or otherwise indicate an item has been retrieved from the shelf for a particular remote shopper or shopping list, and a central computer coupled to the database and a staging area terminal and in communication with electronic user devices configured to present a shopping user interface and/or an item retriever user interface.

In another embodiment, a shopping system is provided that includes a selection user interface configured to receive a shopping list, a database of shopping lists, an item retriever user interface configured to display multiple shopping lists stored by the database and receive a list selection such that the selected shopping list is checked out to the item retriever, and a central computer coupled to the database and a point of sale terminal. By one approach, the central computer presents a set of shopping lists via the item retriever user interface from the database of shopping lists, receives a list selection, receive (from the point of sale terminal) an indication that one or more of the requested items has been retrieved, and updates the database accordingly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A crowd-sourced shopping system comprising:
a shopping user interface configured to receive a shopping list from a user;
a database of a plurality of shopping lists created by users via the shopping user interface;
an item retriever user interface configured to display multiple shopping lists stored by the database;
a central computer coupled to the database and in communication with electronic user devices configured to present one or more of the shopping user interface and the item retriever user interface, the central computer configured to:
present a set of shopping lists to an item retriever located within a retail location via the item retriever user interface;
receive a list selection from the set of shopping lists presented to the item retriever, the selected list having a plurality of requested items;
providing, via the item retriever user interface, the item retriever an opportunity to indicate that one of the plurality of requested items from the selected list has been retrieved from a shelf location of the retail location;
updating the selected list in the database of the plurality of shopping lists to indicate a retrieved status of the requested item in the shopping list; and
present an updated set of shopping lists to one or more additional item retrievers based on the updated database.

2. The system of claim 1 wherein the central computer is further configured to present one of the plurality of shopping lists to more than one item retriever interface for partial fulfillment.

3. The system of claim 1 wherein the central computer is further configured to update the selected list to indicate that the requested item has been deposited into one of a staging location, tote, or bin.

4. The system of claim 1 wherein the central computer is further configured to determine which of the plurality of shopping lists to present in the set of shopping lists presented to a particular item retriever based on the item retriever's detected location within the retail location.

5. The system of claim 1 wherein the central computer is further configured to receive location information from at least one of the electronic user devices and to determine which of the plurality of shopping lists to display to the item retriever in the set of shopping lists based in part on the location information associated with the electronic user device.

6. The system of claim 1 wherein the central computer is further configured to present, via the shopping user interface, an opportunity to purchase a particular requested item and have one of the item retrievers deliver the particular requested item.

7. The system of claim 8 wherein the central computer is further configured to determine whether to present a delivery option to a particular one of the item retrievers based on a current location of the particular item retriever and a destination of the particular item retriever and subsequently presenting the deliver option to the particular item retriever.

8. The system of claim 9 wherein the central computer is configured to receive a delivered notification from the particular item retriever and update the database of the plurality of shopping lists to indicate that the particular item retriever has delivered the particular requested item.

9. The system of claim 1 wherein the central computer is further configured to receive payment for the requested items after the user arrives at the retail location to claim the plurality of requested items from the user's shopping list.

10. The system of claim 1 wherein the central computer is further configured to receive payment for the requested items from the user upon initial receipt of the user's shopping list.

11. A computer-implemented method comprising:
presenting, via a shopping user interface, an opportunity for a user to create a shopping list;
maintaining a database of a plurality of shopping lists created by users via the shopping user interface;
presenting to an item retriever in a retail location, via an item retriever user interface, a set of shopping lists from the plurality of shopping lists;
receiving a list selection from the set of shopping lists presented to the item retriever, the selected list having a plurality of requested items;
providing, via the item retriever user interface, the item retriever an opportunity to indicate that one of the plurality of requested items from the selected list has been retrieved from a shelf location of the retail location;
updating the selected list in the database of the plurality of shopping lists to indicate a retrieved status of the particular one of the requested items in the shopping list; and
presenting an updated set of shopping lists to item retrievers based on the updated database.

12. The method of claim 11 further comprising presenting one of the plurality of shopping lists to multiple item retrievers via multiple item retriever user interfaces for partial fulfillment by at least some of the multiple item retrievers.

13. The method of claim 11 further comprising updating the selected list to indicate that one of the requested items has been deposited into a staging location.

14. The method of claim 11 further comprising determining which of the plurality of shopping lists to present in the set of shopping lists via the item retriever user interface based on a particular item retriever's detected location within the retail location.

15. The method of claim 11 further comprising presenting to users, via the shopping user interface, an opportunity to purchase a particular requested item and have one of the item retrievers deliver the particular requested item.

16. The method of claim 15 further comprising determining whether to present a delivery opportunity to a particular one of the item retrievers based on a current location of the particular item retriever and a destination of the particular item retriever and subsequently presenting the particular item retriever the delivery opportunity.

17. The method of claim 16 further comprising receiving a selection of the delivery opportunity from the particular item retriever and updating the database of the plurality of shopping lists to indicate that the particular item retriever has delivered the particular requested item.

18. The method of claim 11 further comprising receiving payment from the user after the user arrives at the retail location to claim the plurality of requested items from the user's shopping list or upon initial receipt of the user's shopping list.

19. A shopping system comprising:
a selection user interface configured to receive a shopping list from a user;
a database of a plurality of shopping lists created by users via the selection user interface;
an item retriever user interface configured to display multiple shopping lists stored by the database;
a central computer coupled to the database and a point of sale terminal in a retail location and the central computer in communication with electronic user devices configured to present one or more of the selection user interface and the item retriever user interface, the central computer configured to:
present a set of shopping lists for display on an electronic device of an item retriever located within the retail location;
receive a list selection from the set of shopping lists presented to the item retriever, the selected list having one or more requested items;
receive, via the point of sale terminal, an indication that one or more of the requested items have been retrieved; and
update the selected shopping list in the database, according to input received at the point of sale terminal, to indicate a retrieved status of the one or more requested items that have been retrieved.

20. The system of claim 19 wherein the central computer is further configured to indicate a purchased status of the one or more retrieved items when the user has collected the one or more retrieved items from the retail location.

21. The system of claim 19 wherein the selection user interface is configured to receive transaction information from the user without completing an order until the user has collected the one or more retrieved items from the retail location.

22. The system of claim 19 wherein the central computer is configured to receive, from the user, a collection time and a collection location associated with the shopping list.

23. The system of claim 22 wherein the central computer is configured to automatically present the set of shopping lists to the item retriever upon the item retriever entering or approaching the retail location.

24. The system of claim 22 wherein the central computer is configured to determine which of the shopping lists to present to the item retriever based on the collection time and the collection location associated with the shopping list.

25. The system of claim 19 wherein the central computer is further configured to indicate that the selected shopping list is checked-out and unable to be viewed by other item retrievers until the point of sale terminal receives the indication that one or more of the requested items has been retrieved.

26. A computer-implemented method comprising:
presenting, via a selection user interface of a user electronic device, an opportunity for a user to create a shopping list;
maintaining a database of a plurality of shopping lists created by users via the selection user interface;
presenting an item retriever in a retail location, via an item retriever user interface of an electronic device of the item retriever, a set of shopping lists from the plurality of shopping lists;
receiving a list selection from the set of shopping lists presented to the item retriever, the selected list having one or more requested items;
receiving, via a point of sale terminal in the retail location, an indication that at least one of the requested items has been retrieved from a shelf location of the retail location; and
updating the selected shopping list in the database of the plurality of shopping lists, according to input received at the point of sale terminal, to indicate a retrieved status of the at least one of the requested items in the shopping list that has been retrieved.

27. The method of claim 26 further comprising updating the selected list in the database to indicate that one of the requested items has been deposited into a staging location.

28. The method of claim 26 further comprising receiving, via the selection user interface, a collection time and a collection location associated with the shopping list and determining which of the plurality of shopping lists to present in the set of shopping lists via the item retriever user interface based on the collection time and collection location received from the user and the retail location of the item retriever.

29. The method of claim 26 further comprising receiving payment from the user after the user arrives at the retail location to claim the at least one requested item that has been retrieved and indicating a purchased status of the retrieved items after a customer has collected the retrieved items from the retail location.

30. The method of claim 29 further comprising receiving transaction information from the user without completing an order until the customer has collected the retrieved items from the retail location.

31. The method of claim 26 further comprising indicating that the selected shopping list is checked-out and unable to be viewed by other item retrievers until the point of sale terminal receives the indication that at least one of the requested items has been retrieved.
